(19) United States
(12) Patent Application Publication
(10) Pub. No.: US 2011/0195392 A1
(43) Pub. Date: Aug. 11, 2011

(54) LEARNING MAT FOR CHILDREN USING TOY

(75) Inventor: Hee Jeong Kim, Seoul (KR)

(73) Assignee: CHUMSORI CO., LTD., Seoul (KR)

(21) Appl. No.: 13/125,173

(22) PCT Filed: Jun. 11, 2009
(86) PCT No.: PCT/KR2009/003132

§ 371 Date: Apr. 20, 2011

(30) Foreign Application Priority Data
Oct. 29, 2008 (KR) 10-2008-0106231

(51) Int. Cl. G09B 25/00

(52) U.S. Cl. 434/365

(57) ABSTRACT

The present invention relates to a learning mat for children using a toy that is capable of performing learning through the toy having a shape of a character, which induces a child's curiosity while learning and further ensures dynamic physical activities of the child while the learning. The learning mat includes: a mat 100 having learning objects 111 to be learned by a child depicted on the front surface thereof and adapted to wirelessly transmit learning information by section as the learning contents of the learning object 111 touched by the child; and a toy-shaped learning information output member 200 serving as a mat-touching member for touching the learning objects 111 depicted on the mat 100 and wirelessly connected to the mat 100 so as to receive the learning information by section transmitted wirelessly from the mat 100 and to output the received learning information through a speaker, the toy-shaped learning information output member 200 having a toy-shaped housing 201 on the external appearance thereof.

### BACKGROUND OF THE INVENTION

1. Field of the Invention

The present invention relates to a learning mat for children using a toy wherein if a child selects one of learning objects by using the toy having the external appearance of a character capable of inducing the child's curiosity, the learning information on the selected learning object is outputted through the toy having the shape of the character, which continuously induces the child's curiosity while learning and also enables the child to be moved around while learning, thereby ensuring dynamic physical activities of growing children and also providing the satisfaction of their physical development through their dynamic physical activities.

2. Background of the Related Art

As the average number of family members becomes decreased, in recent trends, the interests on the education of children have been increased day by day. With the expansion of the income of the society, moreover, the interests on the education of children are increasingly extended up to infants and toddlers.

A learning method for children in conventional practices is generally carried out through a learning machine wherein if a child's hand or pen (an electronic pen) is touched on a touch screen, learning information made by combining a variety of images (Korean consonants and vowels, English alphabets, pictures, etc.) or sounds (languages and the sounds of nature and machines) is outputted from the learning machine.

However, the conventional learning machine provides the learning method in simple and static ways and induces the child's curiosity just from the audio and visual parts through the images and sounds, thereby unfortunately causing the child's learning desire and interests to be decreased. Further, the conventional learning machine does not provide any physical activities to the child, thereby giving no advantage in decreasing the fatness of children caused by the lack of the physical activities according to their city life.

Moreover, since the conventional learning machine is formed of a solid machine like plastic, the children who have relatively low attention and recognition may collide against the machine or even fall to it, thereby providing the dangers of causing safety accidents.

### SUMMARY OF THE INVENTION

Accordingly, the present invention has been made in view of the above-mentioned problems occurring in the prior art, and it is an object of the present invention to provide a learning mat for children using a toy wherein if a child selects one of learning objects by using the toy having the external appearance of a character capable of inducing the child's curiosity, the learning information on the selected learning object is outputted through the toy having the shape of the character, which continuously induces the child's curiosity while learning.

It is another object of the present invention to provide a learning mat for children using a toy that is capable of enabling the children to be moved around while learning, thereby ensuring dynamic physical activities of growing children and also providing the satisfaction of their physical development through their dynamic physical activities.

To accomplish the above objects, according to the first embodiment of the present invention, there is provided A learning mat for children using a toy, the learning mat comprising: a mat having learning objects to be learned by a child depicted on the front surface thereof and adapted to wirelessly transmit learning information by section as the learning contents on the learning object touched by the child; and a toy-shaped learning information output member serving as a mat-touching member for touching the learning objects depicted on the mat and wirelessly connected to the mat so as to receive the learning information by section transmitted wirelessly from the mat and to output the received learning information through a speaker, the toy-shaped learning information output member having a toy-shaped housing on the external appearance thereof.

The mat comprises a power supply part adapted to supply power; a mat cover having the front surface divided by section and the learning objects depicted on the divided sections; a section coordinate-producing part, inside a mat cover, adapted to produce a coordinate contact signal by section indicating the position of the section touched by using the toy-shaped learning information output member; a data-storing part adapted to store the learning information by section as the learning contents on the learning objects therein; an RF transceiver adapted to convert the learning information by section into an RF signal and to wirelessly transmit the converted RF signal through an antenna; and a controller adapted to extract the learning information by section corresponding to the learning object provided on the section corresponding to the produced coordinate contact signal in the section coordinate-producing part from the data-storing part and to output the extracted learning information by section to the RF transceiver, thereby allowing the extracted learning information by section to be wirelessly transmitted to the toy-shaped learning information output member.

The section coordinate-producing part is configured to have an upper circuit layer, an insulation layer on which contact holes are formed, and a lower circuit layer laminated on each other, the upper circuit layer and the lower circuit layer having contact terminals formed protrudedly therefrom at the corresponding positions to the contact holes of the insulation layer.

A portion of the toy-shaped housing of the toy-shaped learning information output member contacted with the learning objects depicted on the mat is formed of a conductor, and the section coordinate-producing part is formed of a touch-sensing part.

The toy-shaped learning information output member embedded in the toy-shaped housing comprises a power supply part adapted to supply power; an RF transceiver adapted to receive the wireless signal containing the learning information by section transmitted from the mat through an antenna and to extract the received wireless signal containing the learning information by section from the learning information by section; and a speaker adapted to output the learning information by section extracted from the RF transceiver.

The toy-shaped learning information output member embedded in the toy-shaped housing comprises a push switch adapted to generate a melody-generating signal when the toy-shaped housing is touched on the mat; and a melody-generating part adapted to receive the power from the power supply part and to output a melody through the speaker when the melody-generating signal is applied from the push switch.

The toy-shaped learning information output member embedded in the toy-shaped housing comprises: a sound output sensor adapted to produce a power-off signal if the learning information by section is not outputted through the speaker for a previously set period of time; and a relay adapted to turn off the power being supplied from the power supply part when the power-off signal is produced from the sound output sensor.

The learning mat for children using a toy further comprises a detachable exchange sheet provided on the front surface of the mat cover on which the learning objects are depicted, the detachable exchange sheet having another learning objects divided by section on the front surface thereof.

The mat is provided in plural and so as to connect the mats to each other in every direction, the side of one mat is connected to the side of another mat through a connector.

According to the second embodiment of the present invention, there is provided a learning mat for children using a toy, the learning mat comprising: a mat having a front surface divided by section and learning objects depicted on the divided sections and adapted to produce a coordinate contact signal by section that indicates the position of the touched section if any one of the divided sections is touched and to wirelessly transmit the produced coordinate contact signal; a body connected wirelessly to the mat and adapted to receive the coordinate contact signal by section wirelessly transmitted from the mat, to extract learning information by section as the learning contents on the learning object depicted on the section corresponding to the received coordinate contact signal by section, and to wirelessly transmit the extracted learning information by section; and a toy-shaped learning information output member serving as a mat-touching member for touching the learning objects depicted on the mat and wirelessly connected to the body so as to receive the learning information by section transmitted wirelessly from the body, to convert the received learning information by section, and to output the converted learning information by section through a speaker, the toy-shaped learning information output member having a toy-shaped housing on the external appearance thereof.

The mat comprises a power supply part adapted to supply power; a mat cover having the front surface divided by section and the learning objects depicted on the divided sections; a section coordinate-producing part disposed at the inside of the mat cover and adapted to produce a coordinate contact signal by section indicating the position of the section touched by using the toy-shaped learning information output member; a first RF transceiver adapted to convert the learning information by section into an RF signal and wirelessly transmit the converted RF signal through an antenna; and a micro controller adapted to input the learning information by section corresponding to the learning object provided on the section corresponding to the produced coordinate contact signal in the section coordinate-producing part to the first RF transceiver and to wirelessly transmit the inputted learning information by section to the toy-shaped learning information output member.

The section coordinate-producing part is constructed to have an upper circuit layer, an insulation layer on which contact holes are formed, and a lower circuit layer laminated on each other, the upper circuit layer and the lower circuit layer having contact terminals formed protrudedly therefrom at the corresponding positions to the contact holes of the insulation layer.

A portion of the toy-shaped housing of the toy-shaped learning information output member contacted with the learning objects depicted on the mat is formed of a conductor, and the section coordinate-producing part is formed of a touch-sensing part.

The body comprises a power supply part adapted to supply power; a data-storing part adapted to store the learning information by section as the learning contents on the learning objects therein; a first RF transceiver adapted to receive the wireless signal containing the coordinate contact signal by section transmitted from the first RF transceiver provided on the mat through an antenna and to extract the received wireless signal containing the coordinate contact signal by section from the coordinate contact signals by section; a second RF transceiver adapted to convert the learning information by section into an RF signal and to wirelessly transmit the converted RF signal through an antenna; and a controller adapted to extract the learning information by section corresponding to the learning object provided on the section corresponding to the coordinate contact signal inputted from the first RF transceiver from the data-storing part and to output the extracted learning information by section to the second RF transceiver, thereby allowing the extracted learning information by section to be wirelessly transmitted to the toy-shaped learning information output member.

The toy-shaped learning information output member embedded in the toy-shaped housing comprises a power supply part adapted to supply power; a second RF transceiver adapted to receive the wireless signal containing the learning information by section transmitted from the second RF transceiver provided on the body through an antenna and to extract the received wireless signal containing the learning information by section from the learning information by section; and a speaker adapted to output the learning information by section extracted from the second RF transceiver.

The toy-shaped learning information output member embedded in the toy-shaped housing comprises a push switch adapted to generate a melody-generating signal when the toy-shaped housing is touched on the mat; and a melody-generating part adapted to receive the power from the power supply part and to output a melody through the speaker when the melody-generating signal is applied from the push switch.

The toy-shaped learning information output member embedded in the toy-shaped housing comprises a sound output sensor adapted to produce a power-off signal if the learning information by section is not outputted through the speaker for a previously set period of time; and a relay adapted to turn off the power being supplied from the power supply part when the power-off signal is produced from the sound output sensor.

The learning mat for children using a toy further comprises a detachable exchange sheet provided on the front surface of the mat on which the learning objects are depicted, the detachable exchange sheet having another learning objects divided by section on the front surface thereof.

The mat is provided in plural, and so as to connect the mats to each other in every direction, the side of one mat is connected to the side of another mat through a connector.

According to the third embodiment of the present invention, there is provided a learning mat for children using a toy, the learning mat comprising: a mat having a front surface divided by section and learning objects and position guide codes by section depicted on the divided sections, the position guide codes by section indicating the positions of the divided sections; and a toy-shaped learning information output member serving as a mat-touching member for touching the learning objects depicted on the mat and adapted to scan the position guide codes by section indicated on the sections of the mat, to recognize the position of the corresponding section, and to output the learning information by section as the learning contents on the learning object depicted on the recognized section, the toy-shaped learning information output member having a toy-shaped housing on the external appearance thereof.

The toy-shaped learning information output member embedded in the toy-shaped housing comprises a power supply part adapted to supply power; a scanning part adapted to scan the position guide codes by section indicated on the sections of the mat and to produce coordinate contact signals by section; a data-storing part adapted to store the learning information by section as the learning contents on the learning objects therein; a speaker adapted to output the learning information by section; and a controller adapted to extract the learning information by section corresponding to the learning object provided on the section corresponding to the produced coordinate contact signal by section in the scanning part from the data-storing part and to output the extracted learning information by section through the speaker.

The toy-shaped learning information output member embedded in the toy-shaped housing comprises a sound output sensor adapted to produce a power-off signal if the learning information by section is not outputted through the speaker for a previously set period of time; and a relay adapted to turn off the power being supplied from the power supply part when the power-off signal is produced from the sound output sensor.

The learning mat for children using a toy further comprises a detachable exchange sheet provided on the front surface of the mat on which the learning objects are depicted, the detachable exchange sheet having another learning objects and position guide codes by section depicted on the divided sections thereof.

The mat is provided in plural and so as to connect the mats to each other in every direction, the side of one mat is connected to the side of another mat through a connector.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a schematic perspective view showing a learning mat for children using a toy according to a first embodiment of the present invention;

FIG. 2 is a block diagram showing each part constituting a mat in the learning mat for children using a toy in FIG. 1;

FIG. 3 is a block diagram showing each part constituting a toy-shaped learning information output member in the learning mat for children using a toy in FIG. 1;

FIG. 4 is a sectional view showing the laminating structure of the parts constituting a section coordinate-producing part of FIG. 2;

FIG. 5 is a perspective view showing another example of a mat cover in the learning mat for children using a toy in FIG. 1;

FIGS. 6 to 8 are views showing a variety of examples wherein the mat is connected to another mat;

FIG. 9 is a schematic perspective view showing a learning mat for children using a toy according to a second embodiment of the present invention;

FIG. 10 is a block diagram showing each part constituting a mat in the learning mat for children using a toy in FIG. 9;

FIG. 11 is a block diagram showing each part constituting a body in the learning mat for children using a toy in FIG. 9;

FIG. 12 is a block diagram showing each part constituting a toy-shaped learning information output member in the learning mat for children using a toy in FIG. 9;

FIG. 13 is a schematic perspective view showing a learning mat for children using a toy according to a third embodiment of the present invention; and

FIG. 14 is a block diagram showing each part constituting a toy-shaped learning information output member in the learning mat for children using a toy in FIG. 13.

### BRIEF DESCRIPTION OF REFERENCE NUMERALS IN THE DRAWINGS

100,100a,100c: mat; 100b: body

101,101a,101b,210,210a,210b: power supply part

110,110a: mat cover; 111,111a,111c: learning object

120,120a: section coordinate-producing part; 121: upper circuit layer

122: contact hole; 123: insulation layer

124: lower circuit layer; 125,126: contact terminal

127: elastic protrusion; 130,130a,130b: data-storing part

131,131b,131c: internal memory; 132,132b,132c: external memory interface part

133,133b,133c: external memory; 140,220: RF transceiver

141,142: first RF transceiver; 143,221: second RF transceiver

150,150b,151,211: controller; 151: micro controller

160,180: exchange sheet

181: position guide code by section

200,200a,200b: toy-shaped learning information output member

201,201a,201b: toy-shaped housing

230,230a,230b: speaker; 240,240a: push switch

250,250a: melody-generating part; 260,260a: sound output sensor

270,270a: relay; 280: scanning part

300: connector; 301,301a,302,302a: connection jack

303: cable; 303a: connector

304a: metal terminal

### DETAILED DESCRIPTION OF THE PREFERRED EMBODIMENT

Hereinafter, an explanation on a learning mat for children using a toy according to the preferred embodiments of the present invention will be in detail given with reference to the attached drawings. For the brevity of the description, it is noted that the same parts as each other are denoted by the same reference numerals in the drawings, and also, if the parts in first, second and third embodiments of the present invention are the same as each other, the drawings on the same parts in one embodiment are avoided in other embodiments.

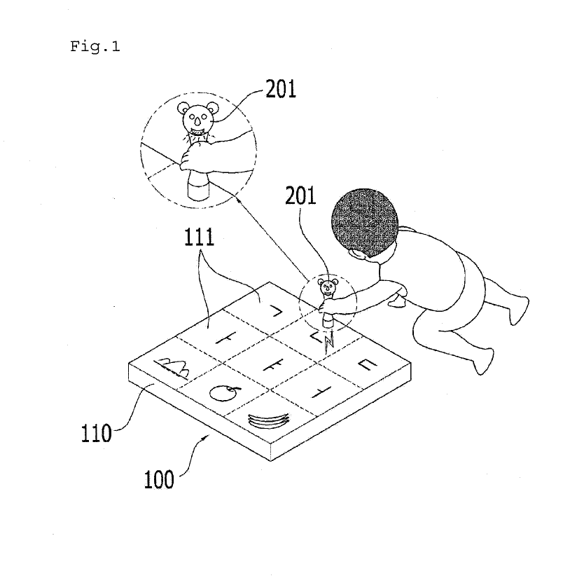

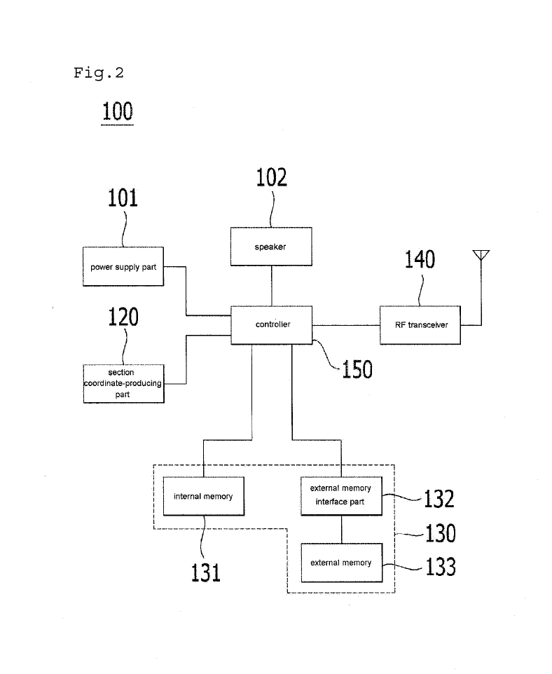

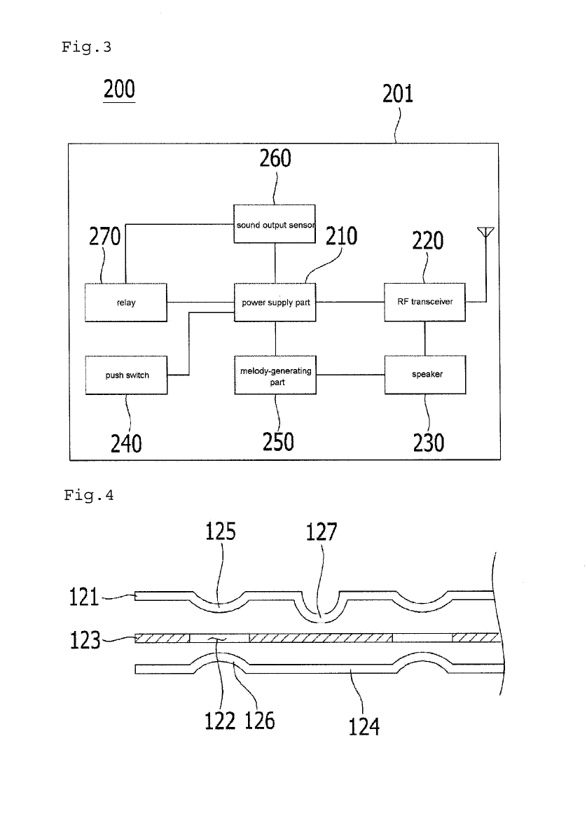

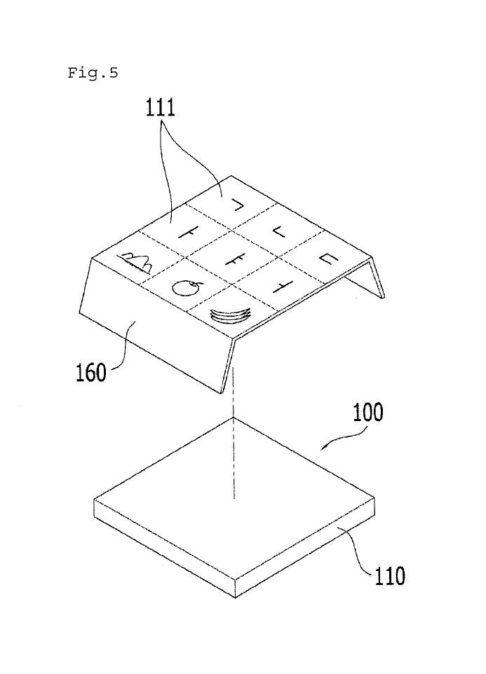

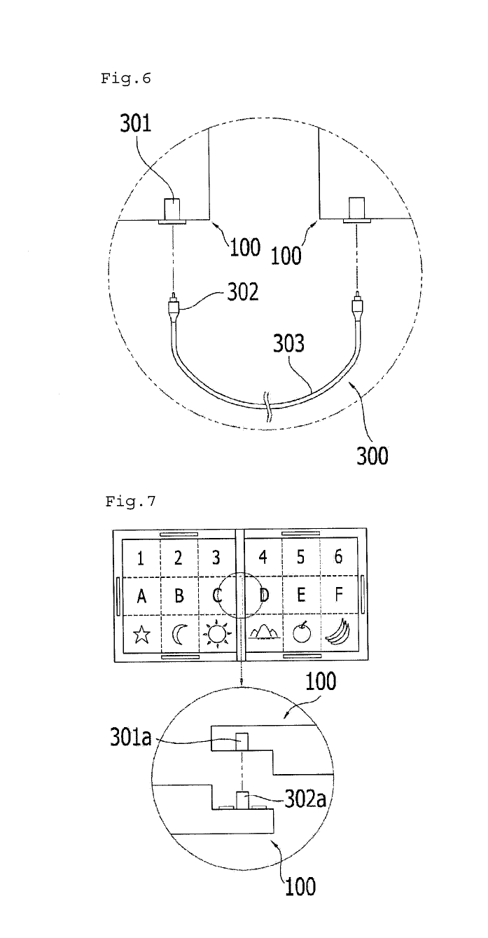

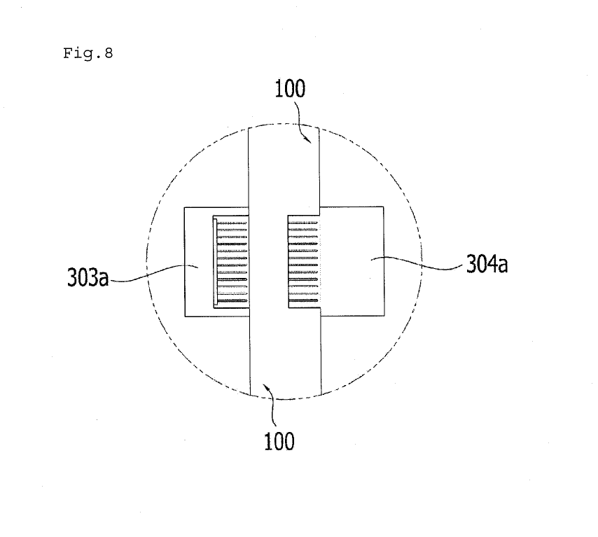

FIG. 1 is a schematic perspective view showing a learning mat for children using a toy according to a first embodiment of the present invention, and FIG. 2 is a block diagram showing each part constituting a mat in the learning mat for children using a toy in FIG. 1, and FIG. 3 is a block diagram showing each part constituting a toy-shaped learning information output member in the learning mat for children using a toy in FIG. 1, FIG. 4 is a sectional view showing the laminating structure of the parts constituting a section coordinate-producing part of FIG. 2.

As shown, a learning mat for children using a toy according to a first embodiment of the present invention largely includes a mat 100 and a toy-shaped learning information output member 200.

Firstly, the mat 100 has learning objects 111 to be learned by a child depicted on the front surface thereof, and if any one of the depicted learning objects is touched, the mat 100 is adapted to transmit a wireless signal containing learning information by section as the learning contents on the touched learning object. The mat 100 includes: upper and lower shock absorbers (which are not shown in the drawings) laminatedly disposed on the top and underside thereof so as to prevent the mat 100 from being broken by external shocks; a power supply part 101, a section coordinate-producing part 120, a data-storing part 130, an RF transceiver 140 and a controller 150, which are disposed between the upper and lower shock absorbers; and a mat cover 110 adapted to cover the mat 100.

Like this, the mat cover 110 of the mat 100 has the front surface divided by section, and the learning objects 111 are depicted on the divided sections. The learning objects 111 are depicted with learning contents (for example, numbers, letters, patterns, the shapes of animals and plants, the shapes of artificial structures, and the like) in accordance with the ages of the children, and the positions of the learning objects 111 are appropriately arranged to provide physical activities to the child.

The power supply part 101 is adapted to supply power needed for the operation of the mat 100 and is selected from DC power, commercial power of AC 220V, a primary battery, and a secondary battery.

If the toy-shaped learning information output member 200 is touched on any one of the sections divided on the front surface of the mat cover 110, the section coordinate-producing part 120 is adapted to produce a coordinate contact signal by section indicating the position of the touched section. The production of the coordinate contact signal by section is carried out through a variety of ways.

Referring to a membrane contact way, first, the section coordinate-producing part 120 is configured wherein an upper circuit layer 121, an insulation layer 123 on which contact holes 122 are formed, and a lower circuit layer 124 are laminated on each other, and the upper circuit layer 121 and the lower circuit layer 124 have contact terminals 125 and 126 formed protrudedly therefrom at the corresponding positions to the contact holes 122 of the insulation layer 123, such that just the contact terminals 125 and 126 corresponding to the section pressed by the touching force of the child are contacted with each other to produce the coordinate contact signal by section.

In this case, the upper circuit layer 121 has elastic protrusions 127 formed on the underside thereof in such a manner as to be protruded in a higher height than the contact terminals 125, thereby improving a degree of precision in the production of the coordinate contact signal by section.

The section coordinate-producing part 120 may produce the coordinate contact signal by section by means of a capacitive overlay. In this case, a conductor is integrally provided on the contacted portion of the toy-shaped housing 201 as the external appearance of the toy-shaped learning information output member 200 with the learning objects 111 depicted on the mat 100, and the section coordinate-producing part 120 is formed of a touch-sensing part, such that if the conductor as the contact portion is contacted with the touch-sensing part in the state where the toy-shaped housing 201 is taken by the hand of the child, the electrostatic capacity is varied and the touch-sensing part serving as the section coordinate-producing part 120 detects given voltage and current values, thereby producing the coordinate contact signal by section corresponding to the contacted section.

The data-storing part 130 in which the learning information by section as the learning contents on the learning objects 111 is stored includes an internal memory 131 embedded basically thereon and an external memory 133 provided from the outside to continuously update the learning information by section.

Thus, the mat 100 has an external memory interface part 132 adapted to perform the transmission of the data stored in the external memory 133.

The external memory 133 is selected from a variety of external memories such as USB (Universal Serial Bus) memory stick, CF (Compact Flash), MMC (Multi Media Card), SD (Secure Digital), XD (xD-Picture Card), SM (Smart Media), and the like, and, accordingly, the external memory interface part 132 that is capable of performing the interface with the external memory selected from the above-mentioned various external memories is provided.

So as to provide learning contents like the learning information by section to a network based-learning server (not shown), the PC (Personal Computer) connected to the learning server and the external memory interface part 132 of the mat 100 are connected to each other by means of a USB cable to perform the downloading of the learning contents.

The RF transceiver 140 is adapted to convert the learning information by section into an RF signal and wirelessly transmit the converted RF signal through an antenna. In this case, the RF transceiver 140 is selected from a variety of modules capable of wirelessly transmitting and receiving data such as a FM transmitter module, an IR module in which infrared data communication is performed, a bluetooth module, an IEEE802.11b module, and the like.

When the coordinate contact signal by section is produced from the section coordinate-producing part 120, the control part 150 is adapted to extract the learning information by section corresponding to the learning object 111 provided on the section corresponding to the produced coordinate contact signal from the data-storing part 130 and to output the extracted learning information by section to the RF transceiver 140, thereby allowing the extracted learning information by section to be wirelessly transmitted to the toy-shaped learning information output member 200.

Further, the mat 100 is connected to a separate speaker 102 through which the learning information by section wirelessly transmitted to the toy-shaped learning information output member 200 is outputted.

The mat 100 having the configuration as mentioned above is basically positioned on the floor when it provides the learning information, but if necessary, it may be positioned on the surface of the wall. In this case, the mat cover 110 desirably has fixing means mounted on the edges thereof, and the fixing means that is cooperatively operated with the surface of the wall is selected from Velcro tape, a zipper, hanging holes and nails, hooks, and the like.

So as to be useable when it is turned over, in addition, the mat 100 according to the present invention may be configured to have the learning objects 111 depicted on the underside thereof in such a manner as to correspond to those depicted on the front surface thereof.

So as to more effectively update the learning information by section applied differently in accordance with the ages of children, the learning objects 111 may be detachably mounted on the front surface of the mat cover 110 constituting the mat 100.

So as to do this, thus, a detachable exchange sheet 160 is provided on the front surface of the mat cover 110 on which the learning objects 111 are depicted, and the detachable exchange sheet 160 has the learning objects 111 divided by section on the front surface thereof. In this case, the detachable mounting means between the mat 100 and the exchange sheet 160 may be selected from a variety of means such as Velcro tape, a zipper, hanging holes and nails, hooks, and the like.

So as to step by step provide the strengths of the physical activities in accordance with the ages of children, also, the mat 100 may be provided in plural, and the mats 100 may be connected in every direction.

The coordinate contact signal by section produced from each mat 100 is wirelessly transmitted to the toy-shaped learning information output member 200. Further, the side of one mat 100 is connected to the side of another mat 100 through a connector 300, such that the coordinate contact signals by section are focused on any one mat 100, and the focused coordinate contact signals are wirelessly transmitted to the toy-shaped learning information output member 200 from one mat 100 on which the coordinate contact signals are focused.

The connector 300 connecting the mats 100 may be various in configuration, and according to one example of the connector 300, a female connection jack 301 formed exposedly on the edge of one mat 100 is connected to another female connection jack 301 by means of a cable 303 having a male connection jack 302 formed at both ends thereof.

According to another example of the connector 300, the mats 100 have both sides facing each other stepped laminatingly to each other, and female and male jacks 301a and 302a are formed on the steps facing each other.

In this case, the female and male jacks 301, 301a, 302 and 302a may be replaced with female and male pins, that is, a connector 303a and a metal terminal 304a.

Further, if new mat 100 is addedly connected to the existing mat 100 by means of the connector 300, the learning information by section on the learning objects 111 provided on the existing mat 100 and the new mat 100 can be updated through the external memory 133, and further, the program of the controller 150 is set to allow the coordinate contact signals by section produced from the newly added mat 100 to be reset in such a manner as to be divided from the coordinate contact signals by section provided from the existing mat 100. Accordingly, the controller 150 of the mat 100 outputs the learning information by section corresponding to the coordinate contact signals by section produced from the added new mat 100.

So as to fix the mats 100 adjacent to each other by means of the connector 300, further, female and male Velcro tapes, buttons and fixing hooks, or female and male zippers may be attached on the four corners of each mat 100, concave and convex portions may be formed on the four corners of each mat 100, or the combination of them may be provided on the four corners of each mat 100, thereby rigidly fixing the mats 100.

The toy-shaped learning information output member 200 serves as a mat-touching member for touching the learning objects 111 depicted on the mat 100 and is wirelessly connected to the mat 100 so as to receive the learning information divided by section transmitted wirelessly from the mat 100 and to output the received learning information through a speaker.

The toy-shaped learning information output member 200 has the toy-shaped housing 201 on the external appearance thereof so as to make the learning child feel excited.

The toy-shaped housing 201 has parts constituting the toy-shaped learning information output member 200 embedded therein, and the parts include a power supply part 210 adapted to supply power, an RF transceiver 220 adapted to receive the wireless signal containing the learning information by section transmitted from the mat 100 through an antenna and to extract the received wireless signal containing the learning information by section from the learning information by section, and a speaker 230 adapted to output the learning information by section extracted from the RF transceiver 220.

The speaker 230 is desirably positioned at a mouth portion of the toy-shaped housing 201, thereby allowing the child to look like he talks to the toy-shaped housing 201 while learning. In addition, an explanation on the configuration and operation of the power supply part 210 and the RF transceiver 220 of the toy-shaped learning information output member 200 is the same as that of the power supply part 101 and the RF transceiver 140 of the mat 100 as mentioned above.

So as to increase the interesting of the learning child, the toy-shaped learning information output member 200 has a push switch 240 adapted to generate a melody-generating signal when the toy-shaped housing 201 is touched on the mat 100 and a melody-generating part 250 adapted to receive the power from the power supply part 210 and to output a melody through the speaker 230 when the melody-generating signal is applied from the push switch 240.

Also, so as to stop the supply of the power from the power supply part 210 provided in the toy-shaped learning information output member 200 if the child does not perform the learning, the toy-shaped learning information output member 200 further includes a sound output sensor 260 adapted to produce a power-off signal if the learning information by section is not outputted through the speaker 230 for a previously set period of time, and a relay 270 adapted to turn off the power being supplied from the power supply part 210 when the power-off signal is produced from the sound output sensor 260.

Hereinafter, an explanation on the learning method through the learning mat for children using a toy according to the first embodiment of the present invention will be given.

If the mats 100 are provided in plural, first, they are connected by means of the connectors 300 and positioned on the surface of wall or the floor. After that, the mats 100 are manipulated and operated for performing learning. At this time, the toy-shaped housing 201 of the toy-shaped learning information output member 200 is taken by the hand of the child.

So as to perform the learning, if any one of the learning objects 111 depicted on the mat 100 is pressed by using the toy-shaped housing 201 of the toy-shaped learning information output member 200, the coordinate contact signal by section that indicates the position of the section of the pressed learning object 111 is produced from the section coordinate-producing part 120 provided on the mat 100.

At this time, the controller 150 of the mat 100 extracts the learning information by section as the learning contents on the learning object 111 corresponding to the produced coordinate contact signal by section from the data-storing part 130 and outputs the extracted learning information by section to the RF transceiver 140. The RF transceiver 140 converts the inputted learning information by section into the RF signal and wirelessly transmits the converted RF signal through the antenna.

Next, the RF transceiver 220 provided in the toy-shaped learning information output member 200 receives the wireless signal containing the learning information by section and extracts just the received wireless signal containing the learning information by section from the learning information by section.

After that, the learning information by section extracted from the RF transceiver 220 is outputted through the speaker 230, such that the child listens to the learning formation on the learning object 111 selected by him through sounds, thereby performing the learning.

Then, the child moves around to select his desired learning objects 111 depicted on each mat 100, thereby repeating the learning, which provides dynamic physical activities as well as learning through play to the growing child. This advantageously gives high learning effects and dynamic physical activities to the child.

Now, the construction and operation of a learning mat for children using a toy according to a second embodiment of the present invention will be described, and for the brevity of the description, the contents that have been already explained in the first embodiment of the present invention will be not included hereinafter.

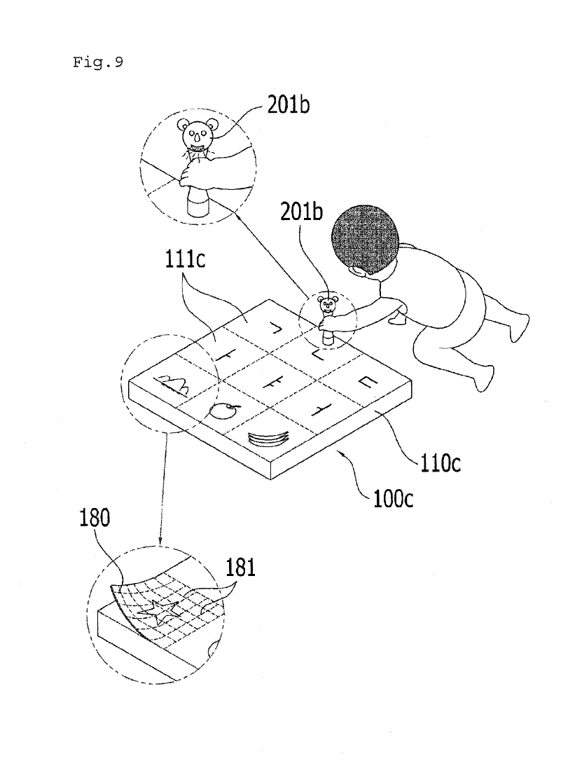

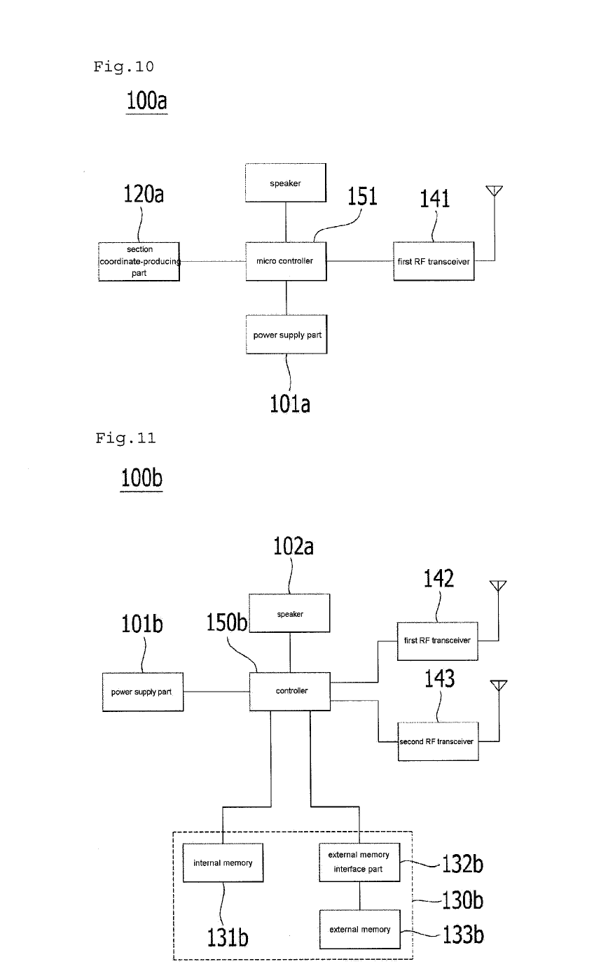

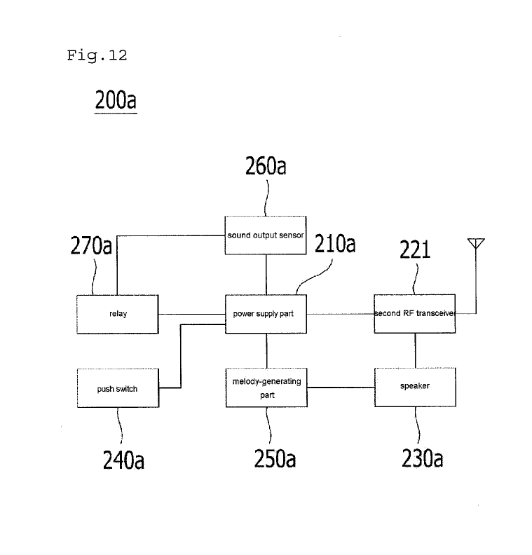

FIG. 9 is a schematic perspective view showing a learning mat for children using a toy according to a second embodiment of the present invention, and FIG. 10 is a block diagram showing each part constituting a mat in the learning mat for children using a toy in FIG. 9, and FIG. 11 is a block diagram showing each part constituting a body in the learning mat for children using a toy in FIG. 9, and FIG. 12 is a block diagram showing each part constituting a toy-shaped learning information output member in the learning mat for children using a toy in FIG. 9.

As shown, the learning mat for children using a toy according to the second embodiment of the present invention includes: a mat 100a having a front surface divided by section and learning objects 111a depicted on the divided sections and adapted to produce a coordinate contact signal by section indicating the position of the section touched and to wirelessly transmit the produced coordinate contact signal by section; a body 100b connected wirelessly to the mat 100a and adapted to receive the coordinate contact signal by section wirelessly transmitted from the mat 100a, to extract learning information by section as the learning contents on the learning object 111a depicted on the section corresponding to the received coordinate contact signal by section, and to wirelessly transmit the extracted learning information by section; and a toy-shaped learning information output member 200a serving as a mat-touching member for touching the learning objects 111a depicted on the mat 100a and wirelessly connected to the body 100b so as to receive the learning information by section transmitted wirelessly from the body 100b, to convert the received learning information by section, and to output the converted learning information by section through a speaker 230a, the toy-shaped learning information output member 200a having a toy-shaped housing 201a on the external appearance thereof.

According to the first embodiment of the present invention, the production of the coordinate contact signal by section and the extraction of the learning information by section are all performed on the mat 100. According to the second embodiment of the present invention, contrarily, the production of the coordinate contact signal by section is performed on the mat 100a, and the extraction of the learning information by section through the coordinate contact signal by section is performed on the body 100b.

The additional formation of the body 100b prevents the mat 100a from being broken by the load caused by the movements of the child on the mat 100a.

According to the configuration of the second embodiment of the present invention, the mat 100a includes a power supply part 101a, a mat cover 110a on which the learning objects 111a are depicted, a section coordinate-producing part 120a, a first RF transceiver 141 and a micro controller 151, and the body 100b includes a power supply part 101b, a data-storing part 130b, a first RF transceiver 142, a second RF transceiver 143 and a controller 150b. Further, the toy-shaped learning information output member 200a having the toy-shaped housing 201a mounted on the external appearance thereof includes a power supply part 210a, a second RF transceiver 221, a speaker 230a, a push switch 240a, a melody-generating part 250a, a sound output sensor 260a and a relay 270a. The second embodiment of the present invention is different from the first embodiment of the present invention in that the body 100b has the first and second RF transceivers 142 and 143 adapted to perform radio communication with the mat 100a and the toy-shaped learning information output member 200a.

Now, the construction and operation of a learning mat for children using a toy according to a third embodiment of the present invention will be described, and for the brevity of the description, the contents that have been already explained in the first and second embodiments of the present invention will be not included hereinafter.

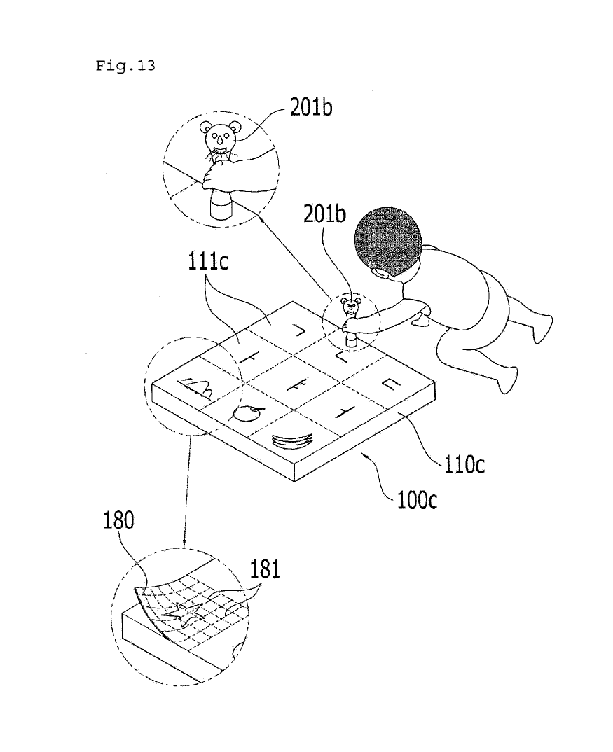

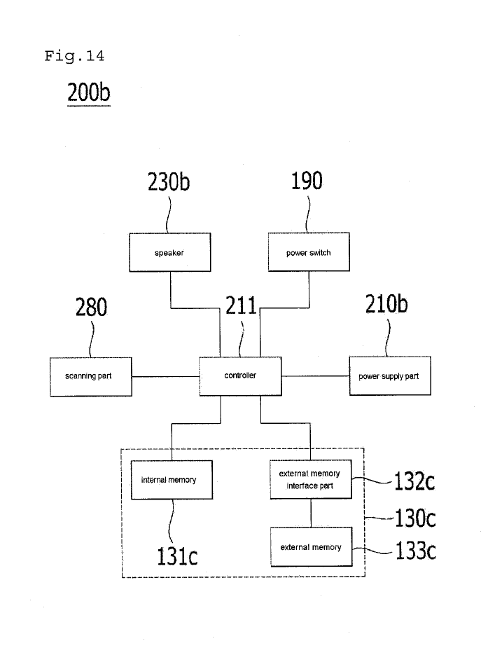

FIG. 13 is a schematic perspective view showing a learning mat for children using a toy according to a third embodiment of the present invention, and FIG. 14 is a block diagram showing each part constituting a toy-shaped learning information output member in the learning mat for children using a toy in FIG. 13.

As shown, the learning mat for children using a toy according to the third embodiment of the present invention includes: a mat 100c having a front surface divided by section and learning objects 111c depicted on the divided sections; and a toy-shaped learning information output member 200b serving as a mat-touching member for touching the learning objects 111c depicted on the mat 100c and adapted to scan position guide codes by section 181 indicated on the sections of the mat 100c, to recognize the position of the corresponding section, and to output the learning information by section as the learning contents on the learning object 111c depicted on the recognized section, the toy-shaped learning information output member 200b having a toy-shaped housing 201b on the external appearance thereof.

The third embodiment of the present invention is different from the first and second embodiments of the present invention in that the algorithm of the production of the section coordinate indicating the position of the section of the learning object 111c selected by the child is different from that in the first and second embodiments, and accordingly, the extraction of the learning information by section is performed by the toy-shaped learning information output member 200b, thereby preventing the product of the present invention from being broken and allowing the configuration to be simplified. According to the configuration of the third embodiment of the present invention, the mat 100c has the position guide codes by section 181 indicating the positions of the divided sections on which the learning objects 111c are depicted, and the toy-shaped learning information output member 200b having the toy-shaped housing 201b mounted on the external appearance thereof includes a power supply part 210b, a scanning part 280 adapted to scan the position guide codes by section 181 indicated on the sections of the mat 100c and to produce coordinate contact signals by section, a data-storing part 130c, a speaker 230b, a controller 211, and a sound output sensor and a relay (which are not shown in the drawings).

In this case, so as to exchange the learning objects 111c depicted on the front surface of the mat 100c with new one, a detachable exchange sheet 180 is provided on the front surface of the mat 100c, and the detachable exchange sheet 180 has another learning objects 111c and position guide codes by section 181 depicted on the divided sections thereof.

According to the third embodiment of the present invention, the activation of the scanning part 280 provided on the toy-shaped learning information output member 200b is carried out in two ways. In the first way of the activation of the scanning part 280, a power switch 190 is provided on the toy-shaped learning information output member 200b, and if the power switch 190 is manipulated to apply power to the toy-shaped learning information output member 200b, the scanning part 280 starts to be activated.

After that, if the scanning part 280 of the toy-shaped housing 201b is brought into contact with the position guide codes by section 181 depicted together with the learning objects 111c on the mat 100c by using the child's hand, the scanning part 280 scans the contacted position guide code by section 181 and produces the coordinate contact signal by section. Next, the controller 211 extracts the learning information by section corresponding to the learning object 111c provided on the section corresponding to the produced coordinate contact signal by section from the data-storing part 130c and outputs the extracted learning information by section through the speaker 230b.

In the second way of the activation of the scanning part 280 provided on the toy-shaped learning information output member 200b, the power switch 190 and a scan activation switch (which is not shown) activating the scanning part 280 through manipulation are provided on the toy-shaped housing 201b of the toy-shaped learning information output member 200b, such that the power switch 190 is manipulated to apply power to the toy-shaped learning information output member 200b.

After that, if the scan activation switch is pressed in the state where the toy-shaped housing 201b is brought into contact with the position guide code by section 181 depicted together with the learning objects 111c on the mat 100c by using the child's hand, a scan activation signal is produced from the scan activation switch and the controller 211 activates the scanning part 280 in response to the produced scan activation signal.

Next, the scanning part 280 scans the contacted position guide code by section 181 and produces the coordinate contact signal by section, and the controller 211 extracts the learning information by section corresponding to the learning object 111c provided on the section corresponding to the produced coordinate contact signal by section from the data-storing part 130c and outputs the extracted learning information by section through the speaker 230b.

The position guide codes by section 181 are selected from bar code patterns, picture patterns, coordinates and the like, so as to satisfy a user's various preferences.

As described above, there is provided the learning mat for children using a toy according to the preferred embodiments of the present invention wherein the selection of the learning objects is carried out by the toy having the external appearance of the character capable of inducing the child's curiosity, which continuously induces the child's curiosity while learning to increase the learning effect.

According to the preferred embodiments of the present invention, in addition, the learning is carried out with the movement of the child, thereby ensuring the physical activities of the growing child and also providing the satisfaction of his physical development through the physical activities.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A child learning mat comprising:
a mat 100 comprising learning objects 111 to be learned by a child and depicted on the front surface of the mat, the mat being adapted to wirelessly transmit learning information by section as the learning contents on the learning objects 111 are touched by the child; and
a toy-shaped learning information output member 200 serving as a mat-touching member for touching learning objects 111 depicted on the mat 100 and wirelessly connected to the mat 100 so as to receive the learning information by section transmitted wirelessly from the mat 100 and to output the received learning information through at least one speaker, the toy-shaped learning information output member 200 having a toy-shaped housing 201 as exterior appearance thereof.

2. The child learning mat according to claim 1, wherein the mat 100 comprises:
a power supply part 101 adapted to supply power;
a mat cover 110 having the front surface divided by section and the learning objects 111 depicted on the divided sections;
a section coordinate-producing part 120, inside the mat cover, adapted to produce a coordinate contact signal by section indicating the position of the section touched by the toy-shaped learning information output member 200;
a data-storing part 130 adapted to store the learning information by section as the learning contents on the learning objects 111 therein;
an RF transceiver 140 adapted to convert the learning information by section into an RF signal and to wirelessly transmit the converted RF signal through an antenna; and
a controller 150 adapted to extract the learning information by section corresponding to the learning object 111 provided on the section corresponding to the produced coordinate contact signal in the section coordinate-producing part 120 from the data-storing part 130 and to output the extracted learning information by section to the RF transceiver 140, thereby allowing the extracted learning information by section to be wirelessly transmitted to the toy-shaped learning information output member 200.

3. The child learning mat according to claim 2, wherein the section coordinate-producing part 120 is configured to be a laminate comprising an upper circuit layer 121, an insulation layer 123 on which contact holes 122 are formed, and a lower circuit layer 124, the upper circuit layer 121 and the lower circuit layer 124 having contact terminals 125 and 126 formed protrudedly therefrom at the corresponding positions to the contact holes 122 of the insulation layer 123.

4. The child learning mat according to claim 2, wherein a portion of the toy-shaped housing 201 contacting the learning objects 111 depicted on the mat 100, is formed of a conductor, and the section coordinate-producing part 120 is formed of a touch-sensing part.

5. The child learning mat according to claim 1, wherein the toy-shaped learning information output member 200 comprises:
a power supply part 210 adapted to supply power;
an RF transceiver 220 adapted to receive the wireless signal containing the learning information by section transmitted from the mat 100 through an antenna and to extract the received wireless signal containing the learning information by section from the learning information by section; and
a speaker 230 adapted to output the learning information by section extracted from the RF transceiver 220.

6. The child learning mat according to claim 5, wherein the toy-shaped learning information output member 200 comprises:
a push switch 240 adapted to generate a melody-generating signal when the toy-shaped housing 201 is touched on the mat 100; and
a melody-generating part 250 adapted to receive the power from the power supply part 210 and to output a melody through the speaker 230 when the melody-generating signal is applied from the push switch 240.

7. The child learning mat according to claim 5, wherein the toy-shaped learning information output member 200 comprises:
a sound output sensor 260 adapted to produce a power-off signal when the learning information by section is not outputted through the speaker 230 for a previously set period of time; and
a relay 270 adapted to turn off the power being supplied from the power supply part 210 when the power-off signal is produced from the sound output sensor 260.

8. The child learning mat according to claim 1, further comprising a detachable exchange sheet 160 provided on the front surface of the mat cover 100 on which the learning objects 111 are depicted, the detachable exchange sheet 160 having another learning objects 111 divided by section on the front surface thereof.

9. The child learning mat according to claim 1, wherein the mat 100 is provided in plural, and the side of one mat 100 is connected to the side of another mat 100 through a connector 300 so that the mats can be connected each other in every direction.

10. A child learning mat comprising:
a mat 100a comprising a front surface divided by section and learning objects 111a depicted on the divided sections, where the mat is adapted to produce a coordinate contact signal by section that indicates the position of the touched section when one of the divided sections is touched and to wirelessly transmit the produced coordinate contact signal;
a body 100b connected wirelessly to the mat 100a, where the body is adapted to receive the coordinate contact signal by section wirelessly transmitted from the mat 100a, to extract learning information by section as the learning contents on the learning object 111a depicted on the section corresponding to the received coordinate contact signal by section, and to wirelessly transmit the extracted learning information by section; and
a toy-shaped learning information output member 200a serving as a mat-touching member for touching the learning objects 111a depicted on the mat 100a and wirelessly connected to the body 100b, so as to receive the learning information by section transmitted wirelessly from the body 100b, to convert the received learning information by section, and to output the converted learning information by section through a speaker 230a, where the toy-shaped learning information output member 200a has a toy-shaped housing 201a as exterior appearance thereof.

11. The child learning mat according to claim 10, wherein the mat 100a comprises:
a power supply part 101a adapted to supply power;
a mat cover 110a having the front surface divided by section and the learning objects 111a depicted on the divided sections;
a section coordinate-producing part 120a disposed at the inside of the mat cover 110a and adapted to produce a coordinate contact signal by section indicating the position of the section touched by the toy-shaped learning information output member 200;
a first RF transceiver 141 adapted to convert the learning information by section into an RF signal and to wirelessly transmit the converted RF signal through an antenna; and
a micro controller 151 adapted to input the learning information by section corresponding to the learning object 111 provided on the section corresponding to the produced coordinate contact signal in the section coordinate-producing part 120 to the first RF transceiver 141 and to wirelessly transmit the inputted learning information by section to the toy-shaped learning information output member 200a.

12. The child learning mat according to claim 11, wherein the section coordinate-producing part 120a is constructed to have an upper circuit layer, an insulation layer on which contact holes are formed, and a lower circuit layer, laminated on each other, the upper circuit layer and the lower circuit layer having contact terminals formed protrudedly therefrom at the corresponding positions to the contact holes of the insulation layer.

13. The child learning mat according to claim 11, wherein a portion of the toy-shaped housing 201a contacting the learning objects 111a depicted on the mat 100a is formed of a conductor, and the section coordinate-producing part 120a is formed of a touch-sensing part.

14. The child learning mat according to claim 11, wherein the body 100b comprises:
a power supply part 101b adapted to supply power;
a data-storing part 130b adapted to store the learning information by section as the learning contents on the learning objects 111a therein;
a first RF transceiver 142 adapted to receive the wireless signal containing the coordinate contact signal by section transmitted from the first RF transceiver 141 provided on the mat 100a through an antenna and to extract the received wireless signal containing the coordinate contact signal by section from the coordinate contact signals by section;
a second RF transceiver 143 adapted to convert the learning information by section into an RF signal and to wirelessly transmit the converted RF signal through an antenna; and
a controller 150b adapted to extract the learning information by section corresponding to the learning object 111 provided on the section corresponding to the coordinate contact signal inputted from the first RF transceiver 142 from the data-storing part 130 and to output the extracted learning information by section to the second RF transceiver 143, thereby allowing the extracted learning information by section to be wirelessly transmitted to the toy-shaped learning information output member 200a.

15. The child learning mat according to claim 10, wherein the toy-shaped learning information output member 200a comprises:
a power supply part 210a adapted to supply power;
a second RF transceiver 221 adapted to receive the wireless signal containing the learning information by section transmitted from the second RF transceiver 143 provided on the body 100b through an antenna and to extract the received wireless signal containing the learning information by section from the learning information by section; and
a speaker 230a adapted to output the learning information by section extracted from the second RF transceiver 221.

16. The child learning mat according to claim 15, wherein the toy-shaped learning information output member 200a comprises:
a push switch 240a adapted to generate a melody-generating signal when the toy-shaped housing 201a is touched on the mat 100a; and
a melody-generating part 250a adapted to receive the power from the power supply part 210a and to output a melody through the speaker 230a when the melody-generating signal is applied from the push switch 240a.

17. The child learning mat according to claim 15, wherein the toy-shaped learning information output member 200a comprises:
a sound output sensor 260a adapted to produce a power-off signal when the learning information by section is not outputted through the speaker 230a for a previously set period of time; and
a relay 270a adapted to turn off the power being supplied from the power supply part 210a when the power-off signal is produced from the sound output sensor 260a.

18. The child learning mat according to claim 10, further comprising a detachable exchange sheet provided on the front surface of the mat 100a on which the learning objects 111a are depicted, the detachable exchange sheet having another learning objects 111a divided by section on the front surface thereof.

19. The child learning mat according to claim 10, wherein the mat 100a is provided in plural, and the side of one mat 100a is connected to the side of another mat 100a through a connector so that the mats can be connected each other in every direction.

20. A child learning mat comprising:
a mat 100c having a front surface divided by section and learning objects 111c and position guide codes by section 181 depicted on the divided sections, the position guide codes by section 181 indicating the positions of the divided sections; and
a toy-shaped learning information output member 200b serving as a mat-touching member for touching the learning objects 111c depicted on the mat 100c and adapted to scan the position guide codes by section 181 indicated on the sections of the mat 100c, to recognize the position of the corresponding section, and to output the learning information by section as the learning contents on the learning object 111c depicted on the recognized section, the toy-shaped learning information output member 200b having a toy-shaped housing 201b as exterior on the external appearance thereof.

21. The child learning mat according to claim 20, wherein the toy-shaped learning information output member 200b comprises:
a power supply part 210b adapted to supply power;
a scanning part 280 adapted to scan the position guide codes by section 181 indicated on the sections of the mat 100c and to produce coordinate contact signals by section;
a data-storing part 130c adapted to store the learning information by section as the learning contents on the learning objects 111 therein;
a speaker 230b adapted to output the learning information by section; and
a controller 211 adapted to extract the learning information by section corresponding to the learning object 111c provided on the section corresponding to the produced coordinate contact signal by section in the scanning part 280 from the data-storing part 130c and to output the extracted learning information by section through the speaker 230b.

22. The child learning mat according to claim 21, wherein the toy-shaped learning information output member 200b comprises:
a sound output sensor adapted to produce a power-off signal when the learning information by section is not outputted through the speaker 230b for a previously set period of time; and
a relay adapted to turn off the power being supplied from the power supply part 210b when the power-off signal is produced from the sound output sensor.

23. The child learning mat according to claim 20, further comprising a detachable exchange sheet 180 provided on the front surface of the mat 100c on which the learning objects 111c are depicted, the detachable exchange sheet 160 having another learning objects 111 and position guide codes by section 181 depicted on the divided sections thereof.

24. The child learning mat according to claim 20, wherein the mat 100c is provided in plural, and the side of one mat 100c is connected to the side of another mat 100c through a connector so that the mats can be connected each other in every direction.
